(19) United States
(12) Patent Application Publication
(10) Pub. No.: US 2026/0330862 A1
(43) Pub. Date: Oct. 22, 2026

(54) METHOD FOR RECOGNIZING ANNOTATIONS IN A PAPER DOCUMENT AND TRANSFERRING THE ANNOTATIONS INTO A DIGITAL DOCUMENT

(71) Applicant: Georg-August-Universität Göttingen Stiftung Öffentlichen Rechts, Göttingen (DE)

(72) Inventors: Tingting Yuan, Göttingen (DE); Xiaoming Fu, Göttingen (DE); Frau Jiaying Wei, Göttingen (DE)

(21) Appl. No.: 19/648,173

(22) Filed: Apr. 15, 2026

(30) Foreign Application Priority Data
Apr. 16, 2025 (DE) 102025114961.5

(51) Int. Cl. G06V 30/413; G06V 10/56; G06V 10/764; G06V 20/70; G06V 30/414; G06V 30/418

(52) U.S. Cl. CPC G06V 30/413; G06V 10/56; G06V 10/764; G06V 20/70; G06V 30/414; G06V 30/418

(57) ABSTRACT

A method for recognizing annotations in a paper document and transferring the annotations into a digital document. The method comprises: capturing an image of a paper page of a paper document using a camera; identifying a target page in the digital document corresponding to the paper page; perspective transformation to align the paper document in the image; determining for each pixel of a plurality of pixels of the image whether the pixel is a colored pixel; creating at least one annotation object based on the colored pixels; inserting the annotation object into the digital document on the target page.

### CROSS REFERENCE TO RELATED APPLICATIONS

The present application claims the benefit of and priority to German Patent Application No. 10 2025 114 961.5, filed Apr. 16, 2025, the entire contents of which is hereby incorporated by reference in its entirety.

### TECHNICAL FIELD

The invention relates to a method for recognizing annotations in a paper document and transferring the annotations into a digital document. The invention also relates to a computer program product, a computer-readable medium, and a mobile device.

### BACKGROUND

Despite advancing digitization, it is still common today for a digitally available document to be printed out and for the printed version to be used for work. For example, many people prefer to read and edit longer texts on paper rather than on a computer. Although modern software for viewing and editing digital documents typically offers numerous options for making annotations, such as highlighting and text annotations, on the digital document, many people value the ability to make annotations on paper with a pen.

Nevertheless, precisely because of the ongoing digitization, it is desirable for the annotations to also be available digitally—not merely as part of a scan of the paper document, but as editable semantic annotation objects within the underlying digital document. Only then can the annotations be further processed, for example.

Therefore, methods for recognizing annotations in a paper document and transferring the annotations to a digital document have been proposed.

In Andreas Schmid, Lorenz Heckelbacher, Raphael Wimmer: “Extracting Handwritten Annotations from Printed Documents Via Infrared Scanning,” CHI EA '22: Extended Abstracts of the 2022 CHI Conference on Human Factors in Computing Systems, 363, 1-6, 2022, it is proposed, for example, to recognize annotations in the paper document using infrared scanning.

Another method is proposed by Nakai, T., K. Kise, and M. Iwamura: “A Method of Annotation Extraction from Paper Documents Using Alignment Based on Local Arrangements of Feature Points,” Ninth International Conference on Document Analysis and Recognition (ICDAR 2007), 1, 23-27, 2007.

Another method is proposed by Nakai Tomohiro, Nobuyuki Kondo, Koichi Kise, and Keinosuke Matsumoto: “Analysis of annotations on documents for recycling of information”, Electrical Engineering in Japan, 165(2):60-68, 2008.

US 2006/0291727 A1 describes another method for recognizing annotations in a paper document and transferring the annotations into a digital document. In this method, annotations are recognized by comparing a scan of a paper page with a target page of the digital document. More specifically, the target page is subtracted from the scan of the paper page, and the remaining information forms the basis for recognizing annotations. However, in practical mobile-device capture scenarios, captured images of paper pages frequently exhibit shadows, reflections, noise, brightness drift, and residual local geometric distortion. In such conditions, approaches based on subtracting a target page from a captured page image may treat non-annotation artifacts as annotation candidates and may also fail to preserve fine-line annotations, such as underlines or squiggles, due to residual misalignment. It is therefore desirable to provide a method that does not rely on such differencing for annotation extraction and that remains simple and reliable also for images captured using mobile devices.

Nowadays, many tasks are performed by people not only digitally but increasingly using mobile devices, particularly smartphones or tablet computers. A method for recognizing annotations in a paper document and transferring the annotations into a digital document should therefore also function reliably and quickly on a mobile device. However, mobile devices typically have relatively limited processing power. Therefore, in order to implement a method for recognizing annotations in a paper document and transferring the annotations into a digital document on a mobile device, it is desirable that the method is particularly simple.

### SUMMARY

One problem underlying the invention is to enable the recognition of annotations in a paper document and the transfer of those annotations into a digital document in a particularly simple yet reliable manner, preferably not only for high-precision acquisition devices such as scanners, but in particular also for images of paper pages captured using a mobile device, even under non-ideal acquisition conditions.

This problem is solved by a method according to claim 1.

A method for recognizing annotations in a paper document and transferring the annotations into a digital document solving the problem comprises: capturing an image of a paper page of a paper document using a camera; identifying a target page in the digital document corresponding to the paper page; performing a perspective transformation to align the paper document in the image; determining, for each pixel of a plurality of pixels in the image, whether the pixel is a colored pixel; creating at least one annotation object based on the colored pixels; inserting the annotation object into the digital document on the target page.

This method is particularly simple yet reliable. Because the method is simple, it can be executed particularly quickly relative to the available computing resources. Thus, the method can also be performed quickly even on a mobile device. In particular, after perspective transformation and color optimization of the captured image, annotation-related colored pixels can be determined in a manner that is less sensitive to illumination variation, shadows, and residual misalignment that may occur in mobile-device capture scenarios.

Perspective transformation ensures that the paper document in the image is aligned according to the target page. This step makes it advantageously possible to capture the image with the camera even under non-ideal conditions while still achieving high recognition accuracy. In particular, it is thus possible to use the camera of a mobile device, such as a commercially available smartphone, to capture the image.

Thus, even with the inherently limited capabilities of a mobile device, annotations in a paper document can be recognized and reliably transferred to a digital document.

Preferably, the plurality of pixels in the image comprises all pixels of the image.

The annotation object is preferably inserted into the digital document on the target page in such a way that its position and orientation correspond to the colored pixels in position and orientation.

Identifying a target page in the digital document corresponding to the paper page can generally be performed before or after the perspective transformation, or during the perspective transformation, to align the paper document in the image.

According to one embodiment, the method comprises creating a mask image that comprises only the colored pixels. The annotation object is preferably created based on the mask image. This further simplifies the method. When creating the mask image, the colored pixels are preferably copied from the image and pasted into the mask image. The image is preferably not altered in the process. The pixels recognized as colored are thus preferably copied from the image and pasted into the mask image at the corresponding positions with the corresponding values. As a result, only the pixels recognized as colored remain visible, while the remaining area initially remains undefined. As a general rule, initially undefined pixels or areas in the mask image are preferably defined as black. This offers advantages for further recognition, particularly in a connected component analysis. Otherwise, there is a risk that a large contiguous white area will be recognized as an annotation object, which would be undesirable.

A pixel typically comprises three color channels: red, green, and blue (RGB). Each of these channels has a specific value, typically ranging from 0 to 255. The values-that is, a red value, a green value, and a blue value-together form the RGB values of the pixel.

Determining whether a pixel is a colored pixel preferably comprises: calculating an average of the pixel's RGB values; determining the deviation of at least one of the RGB values from the average; comparing the deviation to a first threshold value; and classifying the pixel as colored or non-colored based on the comparison. This is a particularly simple yet, for the purposes of annotation recognition, particularly reliable approach to determining whether the pixel is a colored pixel.

The first threshold value may preferably be at least 15, preferably at least 25, and/or at most 60, preferably at most 50, preferably at most 40. The RGB values are preferably defined in the range from 0 to 255. The first threshold value may, for example, be fixed, adjusted, or determined dynamically.

The average of the pixel's RGB values generally corresponds to the pixel's overall brightness. For illustrative purposes, consider a black (0,0,0), a white (255,255,255), or a gray (125,125,125) pixel. Since their RGB values are close to each other-in this case, they are even identical, the deviation from their average is small-in this case, even zero. In contrast, for an example pixel with RGB values of (200, 50, 80), the average is 110, and the respective deviations from the average are 90 (red), 60 (green), and 30 (blue). If, for example, the first threshold value is set to 60, the deviation of the red channel is greater than the first threshold value, and the pixel can be identified as colored.

According to one embodiment of the method, color optimization is performed on the image. This improves detection accuracy and thus the reliability of annotation detection. This step is generally performed before determining, for each pixel of a plurality of pixels in the image, whether the pixel is a colored pixel. The step is preferably performed after perspective transformation. For example, color optimization may comprise brightness normalization, adaptive threshold-based preprocessing, noise reduction, and/or saturation adjustment.

According to one embodiment of the method, creating the annotation object is performed using Connected Components Analysis. This enables particularly reliable annotation recognition. The English term “Connected Components Analysis” can be translated as “Analyse zusammenhängender Komponenten.” However, the English version, which is also more commonly used among German experts, is used here. Connected Component Analysis is preferably applied to the mask image.

The method preferably comprises classifying the annotation object based on annotation types. On the one hand, this allows for more reliable recognition of annotations because targeted recognition methods can be applied depending on the annotation types. On the other hand, classification based on annotation objects offers advantages in the digital document. For example, specific properties can be assigned to different annotation types in a targeted manner.

Useful annotation types include marker-like highlighting, thin-line highlighting, underlining, squiggly underlining, strikethrough, handwritten text, and hand-drawn symbols. Classifying the annotation object based on annotation types may encompass one, several, or all of the aforementioned annotation types, as well as, for example, additional annotation types.

The method also comprises, for example, classifying the annotation object based on negative annotation types, which are designated herein with a prefixed “non”. An annotation object may, for example, comprise one or more negative annotation types. An annotation object may preferably comprise only one positive annotation type.

Classifying the annotation object based on annotation types preferably comprises: identifying a word in the image or on the target page; identifying a word region of the word as an area occupied by the word; determining a number of colored pixels in the word region; determining a proportion of colored pixels in the word region; comparing the proportion of colored pixels in the word region with a second threshold value; classifying the annotation object as a marker-like highlighting based on the comparison. This is a particularly simple yet reliable solution for recognizing and classifying marker-like highlightings as such. Preferably, the annotation object is classified as a marker-like highlighting if the proportion of colored pixels in the word area exceeds the second threshold value. Preferably, the annotation object is classified as a non-marker-like highlighting if the number of colored pixels in the word area does not exceed the second threshold value. The second threshold value can, for example, be fixed, adjusted, or determined dynamically. For example, the word area can be determined such that its height and width correspond to the word.

The method preferably comprises adapting the mask image to the size of the target page of the digital document. This allows for the correct assignment of annotation pixels to be performed easily and reliably.

The method preferably comprises merging adjacent annotation objects classified as marker-like highlighting into larger annotation objects classified as marker-like highlighting. Annotation objects can thus be easily grouped in this manner.

Before the annotation object is classified as a marker-like highlighting, text recognition can be performed, for example, in the image or on the target page within the area of the annotation object. The annotation object is preferably classified as a marker-like highlighting only if text is present within the area of the annotation object in the image or on the target page. If no text is present within the area of the annotation object in the image or on the target page, the annotation is preferably classified as a non-marker-like highlighting.

For example, the method may include: creating a mask image that comprises only the colored pixels; identifying a word in the image or on the target page; identifying a word area of the word as the area occupied by the word; adjusting the mask image to the size of the target page of the digital document; determining a number of colored pixels within the word area; determining a proportion of colored pixels within the word area; comparing the proportion of colored pixels within the word area to a second threshold value; classifying the annotation object as a marker-like highlighting if the proportion of colored pixels in the word area exceeds the second threshold value; merging adjacent annotation objects classified as marker-like highlighting into larger annotation objects classified as marker-like highlighting; detecting text in the image or on the target page within the area of the annotation object and classifying the annotation object as a marker-like highlighting only if text is present within the area of the annotation object in the image or on the target page, and/or classifying the annotation object as a non-marker-like highlighting if no text is present within the area of the annotation object in the image or on the target page.

Classifying the annotation object based on annotation types may preferably include: recognizing text in the image; recognizing text on the target page; comparing the text in the image with the text on the target page; classifying the annotation object as handwritten text based on the comparison. This is a simple approach to recognizing handwritten text. Recognizing text in the image may preferably include optical character recognition (OCR). Recognizing text on the target page may preferably include optical character recognition (OCR). In particular, it is possible to use OCR to recognize text in both the image and on the target page, and to classify differences in the recognized text as handwritten text. However, OCR may not be reliable for handwritten text and, in particular, for hand-drawn symbols. Therefore, the following steps are preferably also performed for the purpose of recognizing handwritten text and/or hand-drawn symbols.

Classifying the annotation object based on annotation types may include: classifying the annotation object as a non-marker-like highlighting; determining a box around the annotation object with a height and width corresponding to the annotation object; determining a proportion of colored pixels within the box; comparing the proportion of colored pixels in the box with a third threshold value; classifying the annotation object as handwritten text or as a hand-drawn symbol based on the comparison. This is a particularly simple yet reliable approach for recognizing handwritten text or hand-drawn symbols.

Preferably, the annotation object is classified as handwritten text or as a hand-drawn symbol if the proportion of colored pixels in the box does not exceed the third threshold value. Preferably, the annotation object is classified as non-handwritten text and/or as non-hand-drawn symbol, and/or as thin-line highlighting, preferably underlining or a squiggly underlining, if the proportion of colored pixels in the box exceeds the third threshold value.

The third threshold value may, for example, be defined as a fixed value, such as at least 25% and/or at most 75%. The third threshold value may, for example, also be adjusted by a person. The third threshold value may, for example, also be determined dynamically. For example, an average of the proportions of colored pixels across several or all annotation objects on the page or across all pages may be calculated, and the third threshold value may be set equal to that average.

According to a preferred embodiment, classifying the annotation object based on annotation types comprises detecting a horizontal length and/or a vertical width of the annotation object and classifying the annotation object as a thin-line highlighting, an underlining, or a squiggly underlining based on the horizontal length and/or the vertical width. This is a particularly simple yet reliable approach for recognizing a thin-line highlighting, an underlining, and/or a squiggly underlining. Preferably, the length and/or the width are each compared with a fourth or fifth threshold value, respectively, and the annotation object is classified as a thin-line highlighting, underlining, or squiggly underlining based on the comparisons. Preferably, the annotation object is classified as a thin-line highlighting, underlining, or squiggly underlining after an attempt to classify the annotation object as a marker-like highlighting has failed or after the annotation object has been classified as a non-marker-like highlighting. Preferably, the annotation object is classified as a thin-line highlighting, underlining, or squiggly underlining after an attempt to classify the annotation object as handwritten text has failed or after the annotation object has been classified as non-handwritten text.

The camera may preferably be a camera of a mobile device, preferably a smartphone or a tablet computer.

The method is preferably a computer-implemented method.

The problem is also solved by a computer program product according to the claim directed thereto. A computer program product solving the problem comprises instructions which, when the program is executed by a computer, cause the computer to perform a method of the type described above.

The problem is also solved by a computer-readable medium according to the claim directed thereto. A computer-readable medium that solves the problem comprises instructions that, when the program is executed by a computer, cause the computer to execute a method of the type described above.

The problem is also solved by a mobile device according to the claim directed thereto. A mobile device that solves the problem is configured to perform a method of the type described above.

Where ordinal numbers are used herein, they serve merely to simplify reference and are not to be understood as limiting the total number of elements for which the ordinal numbers are used. In particular, the presence of a second element does not necessarily imply that a first element is present.

If devices and methods are described herein, the described methods may advantageously be further developed in a manner consistent with the embodiments and individual features of the devices, and vice versa.

### BRIEF DESCRIPTION OF DRAWINGS

The invention is explained below solely by means of examples shown in schematic drawings.

FIG. 1 shows a paper document and a digital document, as well as an arrangement for recognizing annotations in the paper document and transferring the annotations to the digital document.

FIG. 2 illustrates a method for recognizing annotations in a paper document and transferring the annotations to a digital document.

FIG. 3 illustrates an embodiment of the method according to FIG. 2.

FIG. 4 illustrates an embodiment of the method according to FIG. 2.

FIG. 5 illustrates an embodiment of the method according to FIG. 2.

FIG. 6 illustrates an embodiment of the method according to FIG. 2.

FIG. 7 illustrates an embodiment of the method according to FIG. 2.

FIG. 8 illustrates an embodiment of the method according to FIG. 2.

FIG. 9 illustrates an embodiment of the method according to FIG. 2.

FIG. 10 illustrates an embodiment of the method according to FIG. 2.

FIG. 11 illustrates an embodiment of the method according to FIG. 2.

FIG. 12 shows a computer program product.

FIG. 13 shows a computer-readable medium.

### DETAILED DESCRIPTION

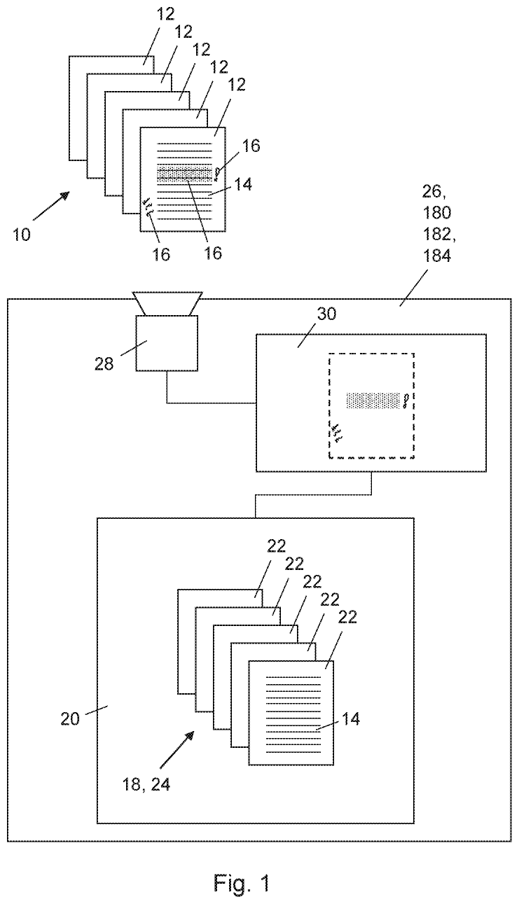

FIG. 1 shows a paper document 10 comprising multiple paper pages 12. At least on the paper page 12 shown in the foreground, the paper document 10 comprises machine-written text 14 and annotations 16.

FIG. 1 shows a digital document 18 in a storage unit 20. The digital document 18 comprises multiple digital pages 22. The digital document 18 contains typewritten text 14 corresponding to that of the paper document 10. The digital document is preferably a PDF document 24.

The paper document 10 shown in FIG. 1 was, for example, printed based on the digital document 18 containing the typewritten text 14. Subsequently, a person added the annotations 16 to the paper document 10 by hand. The goal now is to recognize the annotations 16 in the paper document 10 and transfer them to the digital document 18.

For this purpose, the arrangement 26, also shown in FIG. 1, can be used. The arrangement 26 comprises the storage unit 20 containing the digital document 18, a camera 28, and a processing unit 30.

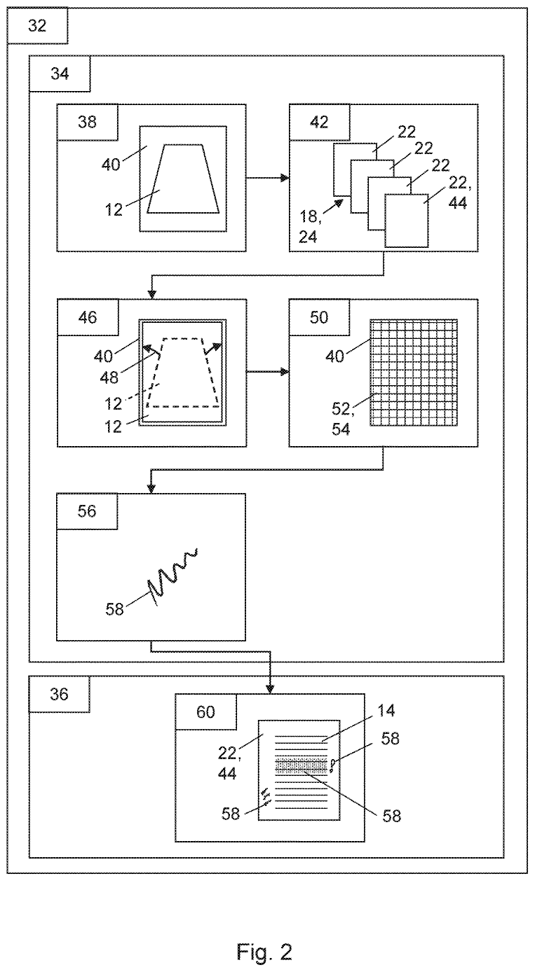

FIG. 2 illustrates, with reference to FIG. 1, a method 32 for recognizing 34 annotations 16 in a paper document 10 and transferring 36 the annotations 16 into a digital document 18. The method 32 comprises capturing 38 an image 40 of a paper page 12 of a paper document 10 using a camera 28. The method 32 comprises identifying 42 a target page 44 in the digital document 18 corresponding to the paper page 12. In some embodiments, the target page is identified by comparing the captured page image with a plurality of candidate pages of the digital document and selecting the best-matching page. The method 32 comprises performing a perspective transformation 46 to align 48 the paper document 10 in the image 40. The method 32 comprises determining 50, for each pixel 52 of a plurality of pixels 52 of the image 40, whether the pixel 52 is a colored pixel 54. The method 32 comprises creating 56 at least one annotation object 58 based on the colored pixels 54. The method 32 comprises inserting 60 the annotation object 58 into the digital document 18 on the target page 44.

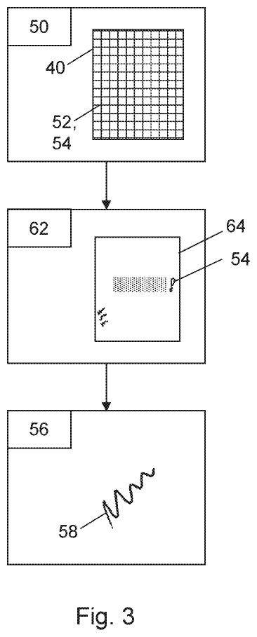

The method 32 according to FIG. 2 may, as illustrated in FIG. 3, preferably include creating 62 a mask image 64 that comprises only the colored pixels 54. The creating 56 the at least one annotation object 58 may preferably be based on the mask image 64.

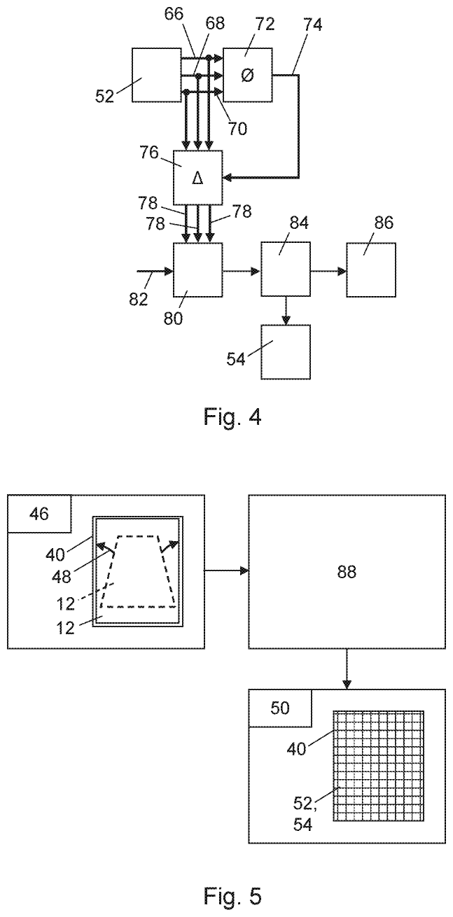

As illustrated in FIG. 4, a pixel 52 preferably comprises three RGB values, namely a red value 66, a green value 68, and a blue value 70. Determining 50 whether the pixel 52 is a colored pixel 54 comprises calculating 72 an average 74 of the RGB values 66, 68, 70 of the pixel 52, calculating 76 a deviation 78 of at least one of the RGB values 66, 68, 70 from the average 74, comparing 80 the deviation 78 with a first threshold value 82, and classifying 84 the pixel 52 as a colored pixel 54 or a non-colored pixel 86 based on the comparison 80. Preferably, the pixel 52 is classified as a colored pixel 54 if at least one deviation 78 is greater than the first threshold value 82.

As illustrated in FIG. 5, the method 32 may preferably include color optimization 88 for the image 40. This step is preferably performed prior to determining 50, for each pixel 52 of a plurality of pixels 52 of the image 40, whether the pixel 52 is a colored pixel 54. The step is preferably performed after the perspective transformation 46.

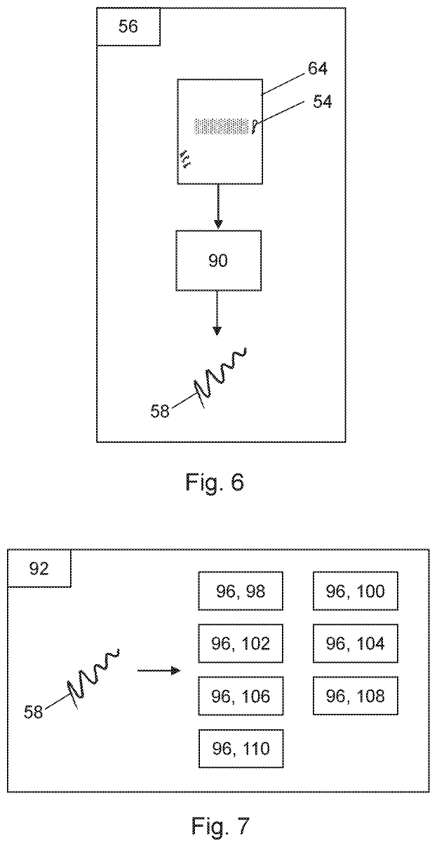

As illustrated in FIG. 6, in method 32, creating 56 the annotation object 58 may preferably be performed using connected components analysis 90.

As illustrated in FIG. 7, the method 32 of FIG. 2 may include classifying 92 the annotation object 58 based on annotation types 96. In the example of FIG. 7, the annotation types 96 used are marker-like highlighting 98, thin-line highlighting 100, underlining 102, squiggly underlining 104, strikethrough 106, handwritten text 108, and/or hand-drawn symbol 110.

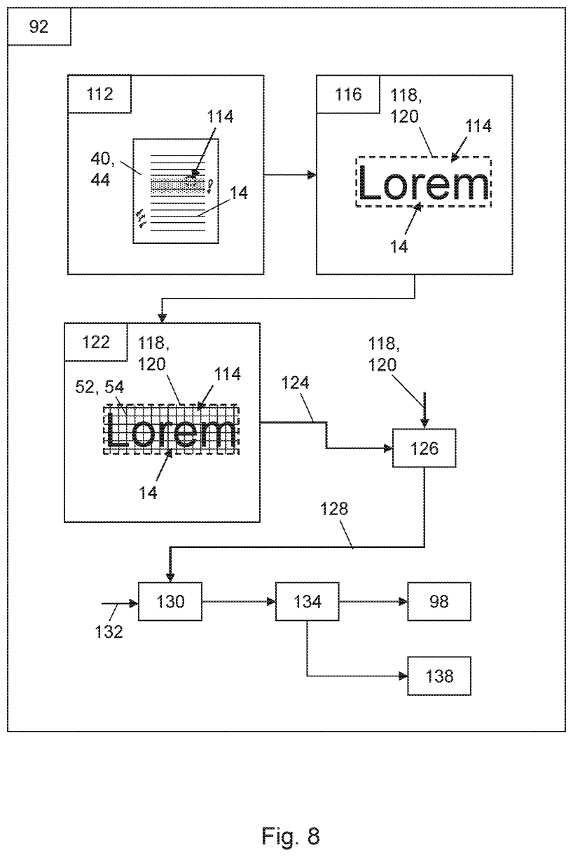

Classifying 92 the annotation object 58 based on annotation types 96 comprises, for example, the steps illustrated in FIG. 8. Classifying 92 the annotation object 58 based on annotation types 96 comprises, in this case, identifying 112 a word 114 in image 40 or on target page 44. Classifying 92 the annotation object 58 based on annotation types 96 comprises determining 116 a word region 118 of the word 114 as an area 120 occupied by the word 114. Classifying 92 the annotation object 58 based on annotation types 96 comprises determining 122 a number 124 of colored pixels 54 within the word region 118. Classifying 92 the annotation object 58 based on annotation types 96 comprises determining 126 a proportion 128 of the colored pixels 54 relative to the word region 118. Classifying 92 the annotation object 58 based on annotation types 96 comprises comparing 130 the proportion 128 of colored pixels 54 in the word region 118 with a second threshold value 132. Classifying 92 the annotation object 58 based on annotation types 96 comprises classifying 134 the annotation object 58 as a marker-like highlighting 98 based on the comparison 130. Preferably, the annotation object 58 is classified as a marker-like highlighting 98 if the proportion 128 of colored pixels 54 in the word region 118 exceeds the second threshold value 132. Preferably, the annotation object 58 is classified as a non-marker-like highlighting 138 if the proportion 128 of colored pixels 54 in the word region 118 does not exceed the second threshold value 132.

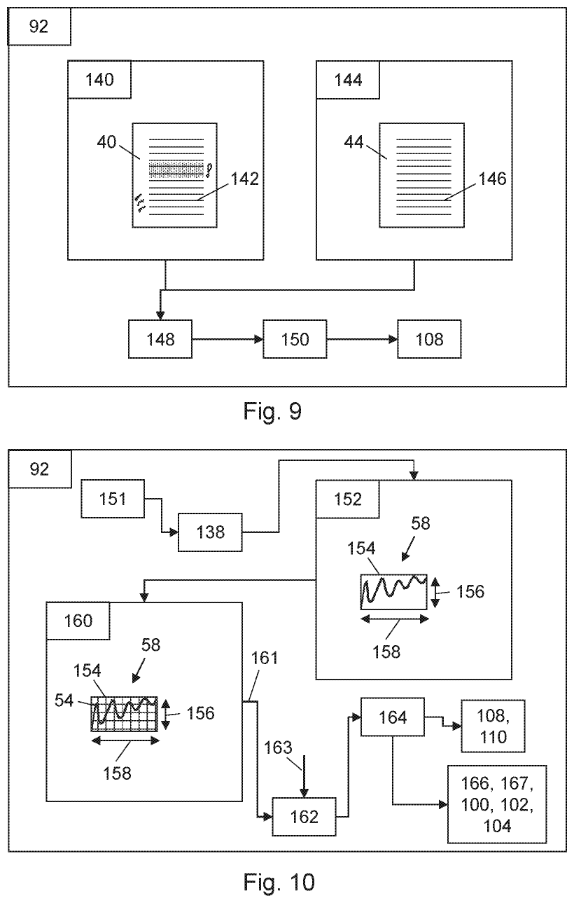

Classifying 92 annotation object 58 based on annotation types 96 may, for example, include the steps illustrated in FIG. 9. Classifying 92 the annotation object 58 based on annotation types 96 comprises, in this case, recognizing 140 text 142 in image 40 and recognizing 144 text 146 on the target page 44. Classifying 92 the annotation object 58 based on annotation types 96 comprises comparing 148 the text 142 in image 40 with the text 146 on the target page 44 and classifying 150 the annotation object 58 as handwritten text 108 based on the comparison 148. The recognition 140 of text 142 in image 40 may preferably comprise optical character recognition (OCR) 152. The recognition 144 of text 146 on the target page 44 may preferably comprise Optical Character Recognition (OCR) 152. Thus, for example, text found in image 44 but not found on the target page 44 may be recognized as annotation object 58 and classified as handwritten text 108.

Classifying 92 of the annotation object 58 based on annotation types 96 may, for example, comprise the steps illustrated in FIG. 10. Classifying 92 the annotation object 58 based on annotation types 96 comprises initially classifying 151 the annotation object 58 as a non-marker-like highlighting 138, for example as illustrated in FIG. 8. Classifying 92 the annotation object 58 based on annotation types 96 comprises determining 152 a box 154 around the annotation object 58 with a height 156 and a width 158 corresponding to the annotation object 58. Classifying 92 the annotation object 58 based on annotation types 96 comprises determining 160 a proportion 161 of colored pixels 54 within the box 154.

Classifying 92 the annotation object 58 based on annotation types 96 comprises, as shown in FIG. 10, comparing 162 the proportion 161 of colored pixels 54 in the box 154 with a third threshold value 163. Classifying 92 the annotation object 58 based on annotation types 96 comprises classifying 164 the annotation object 58 as handwritten text 108 or as a hand-drawn symbol 110 based on the comparison 162. In this process, the annotation object 58 is preferably classified as handwritten text 108 or as a hand-drawn symbol 110 if the proportion 161 of colored pixels 54 in the box 154 does not exceed the third threshold value 163. Preferably, the annotation object 58 is classified as non-handwritten text 166 and/or as a non-hand-drawn symbol 167 and/or as a thin-line highlighting 100, such as underlining 102 or a squiggly underlining 104, when the proportion 161 of colored pixels 54 in box 154 exceeds the third threshold value 163.

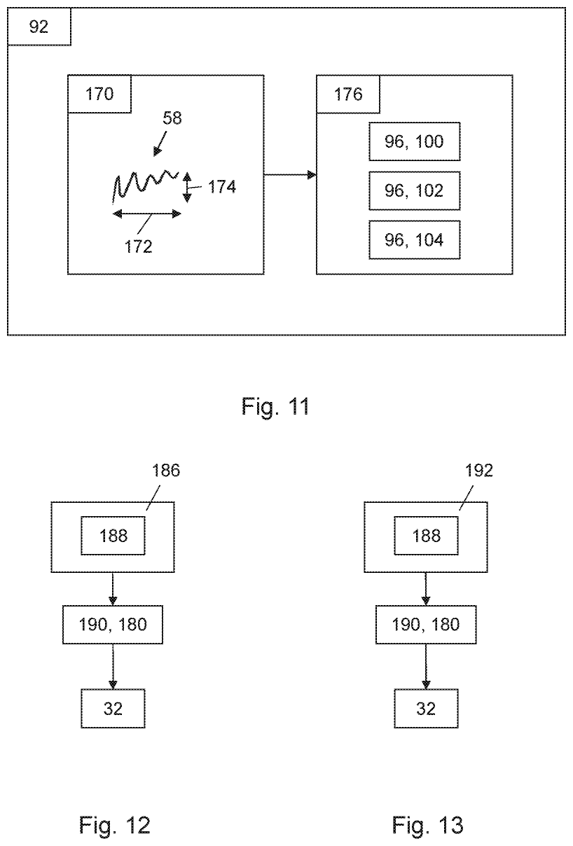

Classifying 92 the annotation object 58 based on annotation types 96 may, for example, comprise the steps illustrated in FIG. 11. Classifying 92 the annotation object 58 based on annotation types 96 comprises, in this case, detecting 170 a horizontal length 172 and a vertical width 174 of the annotation object 58. Classifying 92 the annotation object 58 based on annotation types 96 comprises classifying 176 the annotation object 58 as a thin-line highlighting 100, an underlining 102, or a squiggly underlining 104 based on the horizontal length 172 and the vertical width 174.

In FIG. 1, the device 26 may, for example, be a mobile device 180, such as a smartphone 182 or a tablet computer 184. In this case, the camera 28 is a camera 28 of a mobile device 180, specifically a smartphone 182 or a tablet computer 184. The mobile device 180 is configured to perform the method 32 according to FIG. 2 and preferably according to FIGS. 3 through 11.

FIG. 12 illustrates a computer program product 186 comprising instructions 188 which, when the program is executed by a computer 190, such as a mobile device 180, cause it to perform a method 32 according to FIG. 2 and preferably according to FIGS. 3 through 11.

FIG. 13 illustrates a computer-readable medium 192 comprising instructions 188 which, when the program is executed by a computer 190, such as a mobile device 180, cause it to perform a method 32 according to FIG. 2 and, preferably, according to FIGS. 3 through 11.

Where similar or identical elements are shown in different figures, reference numerals are assigned accordingly. Multiple descriptions of similar or identical elements have been avoided for the sake of clarity. Nevertheless, the embodiments shown in the figures may be combined with one another and further developed in accordance with the other embodiments as well as through their individual features.

### LIST OF REFERENCE NUMERALS

10 Paper document
12 Paper page
14 Machine-written Text
16 Annotation
18 Digital document
20 Storage unit
22 Digital page
24 PDF document
26 Arrangement
28 Camera
30 Storage unit
32 Method
34 Recognizing
36 Transferring
38 Capturing
40 Image
42 Identifying
44 Target page
46 Perspective Transformation
48 Alignment
50 Determining
52 Pixel
54 Colored pixel
56 Creating
58 Annotation object
60 Inserting
62 Creating
64 Mask Image
66 Red value
68 Green value
70 Blue value
72 Determining
74 Average
76 Determining
78 Deviation
80 Comparing
82 First threshold
84 Classifying
86 Non-colored Pixel
88 Color optimization
90 Connected Component Analysis
92 Classifying
96 Annotation Type
98 Marker-like Highlighting
100 Thin-line highlighting
102 Underlining
104 Squiggly underlining
106 Strikethrough
108 Handwritten text
110 Hand-drawn symbol
112 Determining
114 Word
116 Determining
118 Word Area
120 Area
122 Determining
124 Number
126 Determining
128 Proportion
130 Comparing
132 Second threshold
134 Classifying
138 Non-marker-like highlighting
140 Recognizing
142 Text
144 Recognizing
146 Text
148 Comparing
150 Classifying
151 Classifying
152 Determining
154 Box
156 Height
158 Width
160 Determining
161 Proportion
162 Comparing
163 Third threshold
164 Classifying
166 Non-handwritten text
167 Non-hand-drawn symbol
170 Recognizing
172 Horizontal length
174 Vertical width
176 Classifying
180 Mobile device
182 Smartphone
184 Tablet Computer
186 Computer Program Product
188 Instructions
190 Computer
192 Computer-readable medium

1. A method for recognizing annotations in a paper document and transferring the annotations into a digital document, wherein the method comprises:
capturing an image of a paper page of a paper document using a camera;
identifying a target page in the digital document corresponding to the paper page;
performing a perspective transformation to align the paper document in the image;
determining for each pixel of a plurality of pixels of the image whether the pixel is a colored pixel;
creating at least one annotation object based on the colored pixels;
inserting a annotation object into the digital document on the target page.

2. The method according to claim 1, further comprising:
creating a mask image which comprises only the colored pixels, wherein creating the annotation object is based on the mask image.

3. The method according to claim 1, wherein:
a pixel comprises three RGB values, and
determining whether the pixel is a colored pixel comprises:
determining an average of RGB values of the pixel;
determining a deviation of at least one of the RGB values from the average;
comparing the deviation with a first threshold value; and
classifying the pixel as a colored pixel or as a non-colored pixel based on the comparison.

4. The method according to claim 1, wherein a color optimization is performed for the image.

5. The method according to claim 1, wherein creating the annotation object is performed using connected components analysis.

6. The method according to claim 1, further comprising:
classifying the annotation object based on annotation types;
wherein the annotation types comprise at least one of marker-like highlighting, thin-line highlighting, underlining, squiggly underlining, strikethrough, handwritten text, hand-drawn symbol (110), and combinations thereof.

7. The method according to claim 6, wherein classifying the annotation object based on annotation types comprises:
identifying a word in the image or on the target page;
determining a word region of the word as an area occupied by the word;
determining a number of colored pixels within the word region;
determining a proportion of the colored pixels in the word region;
comparing the proportion of colored pixels in the word region with a second threshold value; and
classifying the annotation object as a marker-like highlighting based on the comparison;
wherein the annotation object is classified as a marker-like highlighting if the proportion of colored pixels in the word region exceeds the second threshold value and
wherein the annotation object is classified as a non-marker-like highlighting if the proportion of colored pixels in the word region does not exceed the second threshold value.

8. The method according to claim 6, wherein classifying the annotation object based on annotation types comprises:
detecting text in the image;
detecting text on the target page;
comparing the text in the image with the text on the target page; and
classifying the annotation object as handwritten text based on the comparison.

9. The method according to claim 6, wherein classifying the annotation object based on annotation types comprises:
classifying the annotation object as a non-marker-like highlighting;
determining a box around the annotation object with a height and a width (158) corresponding to the annotation object;
determining a proportion of colored pixels within the box;
comparing the proportion of colored pixels in the box with a third threshold value; and
classifying the annotation object as handwritten text or as a hand-drawn symbol (110) based on the comparison;
wherein the annotation object is classified as handwritten text or as a hand-drawn symbol if the proportion of colored pixels in the box does not exceed the third threshold value, and
wherein the annotation object is classified as non-handwritten text (166) and/or non-hand-drawn symbol and/or as a thin-line highlighting, preferably underlining or a squiggly underlining, if the proportion of colored pixels in the box exceeds the third threshold value.

10. The method according to claim 6, wherein the classifying of the annotation object based on annotation types comprises:
detecting a horizontal length and/or a vertical width of the annotation object; and
classifying the annotation object as a thin-line highlighting, an underlining, or a squiggly underlining based on the horizontal length and/or the vertical width.

11. The method according to claim 1, wherein the camera is a camera of a mobile device.

12. A computer program product comprising instructions that, when the program is executed by a computer, causes the computer to perform a method according to claim 1.

13. A computer-readable medium comprising instructions that, when the program is executed by a computer, causes the computer to perform a method according to claim 1.

14. A mobile device configured to perform a method according to claim 1.

15. The method according to claim 11, wherein the mobile device is a smartphone or a tablet computer.
